(19) United States
(12) Patent Application Publication
(10) Pub. No.: US 2017/0354482 A1
(43) Pub. Date: Dec. 14, 2017

(54) MAXILLARY SKELETAL EXPANDER DEVICE AND METHOD

(71) Applicant: Paul KIM, Diamond Bar, CA (US)

(72) Inventor: Paul KIM, Diamond Bar, CA (US)

(21) Appl. No.: 15/680,036

(22) Filed: Aug. 17, 2017

Related U.S. Application Data
(63) Continuation-in-part of application No. 29/566,586, filed on Jun. 1, 2016, now Pat. No. D799041.

(51) Int. Cl. A61C 7/10

(52) U.S. Cl. CPC A61C 7/10

(57) ABSTRACT

The present invention discloses a maxillary skeletal expander device and methods of making and using the same.

### CROSS-REFERENCE TO PRIOR APPLICATION

This application is a continuation-in-part of U.S. Design Application No. 29/566,586, filed on Jun. 1, 2016, the teaching of which is incorporated herein by reference in its entirety.

### FIELD OF THE INVENTION

The present invention generally relates an orthodontic device and more specifically a device for expanding upper jaw of a patient, and more particularly to maxillary skeletal expanders.

### BACKGROUND OF THE INVENTION

Traditionally, orthodontists have used a Rapid Palatal Expander (“RPE”) attached to an orthodontic appliance to force an expansion between the plates in the palatal bone. While this technique is frequently used, the success of using such method on adult patients is minimal due to the development of bone density of the palatal region. U.S. Pat. No. 9,351,810 to Dr. Moon addresses this complication in adult patients by incorporating micro-implants into the RPE orthodontic appliance (“MARPE”). The micro-implants serve as additional anchorage points, which allows the RPE to exert far greater force in moving the plates in the palatal bone than without the micro-implants. These micro-implants are anchored, or screwed in, to the palatal bone directly from four holes made directly in the RPE appliance. The essential components of the MARPE include the RPE and four welded arms that are attached to two molar bands. The RPE is the “engine” behind the appliance, and is engaged by turning a gear mechanism that exerts outward force onto the palatal bone and surrounding teeth, thereby causing an expansion between the two plates of the palatal bone.

U.S. Pat. No. 9,351,810's FIGS. 3-5, describes the maxillary skeletal expander by Moon using mini-screws, which includes a two halves of the device body 100, arms 200 having one end fixed to the bodies 100 and the other end extending toward teeth B, an extending screw 300 having both side portions inserted into the two halves of the device body 100 to adjust a space between the two halves of the device body 100, guide rails 400 having both sides inserted into the two halves of the device body 100 and guiding a movement of the device 100, a key hole 500 integrally formed with the extending screw 300, screw insertion portions 110 integrally formed with the bodies 100 and having screw insertion holes 112 guiding mini-screws S implanted to an upper jaw, and a teeth fixing part 600 integrally formed with the arms 200 and fixed to teeth of a patient.

However, there are a number of shortcomings in the MARPE device. For example, there is a gap between the hole in the RPE (where the micro-implants are inserted) and the palatal region, thus allowing (1) room for potential error during the implantation process, (2) a greater likelihood of food particles being caught and causing bad breath and poor oral hygiene, and (3) external forces to shake the mini-implant out of place.

Therefore, there is a continuing need for strategies and agents for treating or ameliorating osteoporosis. The embodiments below address the above described problems and needs.

### SUMMARY OF THE INVENTION

In one aspect of the present invention, it is provided a maxillary skeletal expander device, comprising:
two halves of a device body, each halve having a middle portion and at least one anchoring leg configured to be fixed directly to a palatine bone;
at least two arms, each of the at least two arms having a proximal end fixed to one of the two halves of the device body and a distal end extending toward teeth;
a lock screw rotatably coupled to the two halves of the device body and configured to adjust a distance between the two halves of the device body;
a pair of slide rails for guiding a movement of the two halves of the device body, one slide rail having a first end slidably inserted into or fixed to a fist halve of the device body and a second end slidably inserted into a second halve of the device body, and the other slide rail having a first end slidably inserted into or fixed to the second halve of the device body and a second end slidably inserted into the first halve of the device body.

In some embodiments of the invention device, optionally in combination with any of the various embodiments disclosed herein, there can be a gap between a top surface of the anchoring leg and a portion of a top surface of the middle portion, which gap is sufficient to allow cleaning, the top surface of the anchoring leg and the top surface of the middle portion are configured to face a palate. In some embodiments, the gap can be larger than 1 mm.

In some embodiments of the invention device, optionally in combination with any of the various embodiments disclosed herein, the lock screw comprises a nut configured to be turned by a wrench.

In some embodiments invention device, optionally in combination with any of the various embodiments disclosed herein, each of the pair of slide rails includes a mechanism to prevent a disengagement of the pair of slide rails from the two halves of the device body.

In some embodiments invention device, optionally in combination with any of the various embodiments disclosed herein, the mechanism is a notch and wherein the nut includes a lock strap and wherein the notch accommodates the lock strap.

In some embodiments invention device, optionally in combination with any of the various embodiments disclosed herein, the device comprises four arms, each of the two halves of the device body having two arms attached thereto, one to its left side and the other to its right side.

In some embodiments invention device, optionally in combination with any of the various embodiments disclosed herein, the device comprising four anchoring legs, each of the two halves of the device body having two anchoring legs attached thereto, one to its left end and the other to its right end.

In some embodiments invention device, optionally in combination with any of the various embodiments disclosed herein, the device further comprises:
a pair of teeth fixing parts, the distal end of each arm attached to one halve of the device body being secured to one of the pair of teeth fixing parts, and the distal end of each arm attached to the other halve of the device body being secured to the other of the teeth fixing parts.

In some embodiments invention device, optionally in combination with any of the various embodiments disclosed herein, the anchoring leg comprises an opening to allow an implant to be inserted into the palatine bone so as to cause the maxillary skeletal expander to be fixed to the palatine bone.

In some embodiments invention device, optionally in combination with any of the various embodiments disclosed herein, the implant is a screw, a nail.

In some embodiments invention device, optionally in combination with any of the various embodiments disclosed herein, the implant has a cross-section of a circle, a square or a rectangular.

In some embodiments invention device, optionally in combination with any of the various embodiments disclosed herein, the device comprises four arms, wherein the four arms and the slide rails are configured such that:
a first arm having a distal end extending toward teeth, a proximal end slidably coupled to the first body, a portion fixed to the second body, and a slide portion extending from the portion fixed to the second body to the proximal end, the slide portion guiding a movement of the first and second bodies;
a second arm having a distal end extending toward teeth and a proximal end secured to the second body;
a third arm having a distal end extending toward teeth, a proximal end slidably coupled to the second body, a portion fixed to the first body, and a slide portion extending from the portion fixed to the first body to the proximal end, the slide portion guiding a movement of the first and second bodies; and
a fourth arm having a distal end extending toward teeth and a proximal end secured to the first body.

In some embodiments invention device, optionally in combination with any of the various embodiments disclosed herein, a width of the two legs along a direction of the movement of the two halves of the device body being less than a width of the middle portion.

In some embodiments invention device, optionally in combination with any of the various embodiments disclosed herein, the lock screw comprises a nut configured to be rotated by a wrench; and the slide rail comprises a notch that accommodates the nut to prevent a disengagement of the slide rail from the one or both halves of the device body.

In some embodiments invention device, optionally in combination with any of the various embodiments disclosed herein, the nut includes a lock strap that prevents a disengagement of the slide rail from the one or both halves of the device body.

In some embodiments invention device, optionally in combination with any of the various embodiments disclosed herein, a cross section of the slide rail has a shape of a rectangle.

In another aspect of the present invention, it is provided a method of fabricating a maxillary skeletal expander device, which method comprising:
detecting a maxillary skeletal disorder in a patient;
prescribing a maxillary skeletal expander device of invention to correct the maxillary skeletal disorder in the patient;
fabricating the maxillary skeletal expander device of invention;
applying the maxillary skeletal expander device of invention to the patient; and
periodically adjusting the maxillary skeletal expander device by turning the lock screw on the device until a desired result of maxillary skeletal expansion is achieved,
   wherein the maxillary skeletal expander device is according to the various embodiments disclosed above and below.

In some embodiments of the invention method, optionally in combination with any of the various embodiments disclosed herein, a metallic or non-metallic material (e.g., a biocompatible polymeric material) can be used to form any or all parts of the device.

In another aspect of the present invention, it is provided a method of treating a maxillary skeletal disorder, comprising:
detecting a maxillary skeletal disorder in a patient;
prescribing a maxillary skeletal expander device of invention to correct the maxillary skeletal disorder in the patient;
fabricating the maxillary skeletal expander device of invention;
applying the maxillary skeletal expander device of invention to the patient; and
periodically adjusting the maxillary skeletal expander device by turning the lock screw on the device until a desired result of maxillary skeletal expansion is achieved,
   wherein the maxillary skeletal expander device is the various embodiments disclosed above and below.

### BRIEF DESCRIPTION OF THE DRAWINGS

FIG. 1 shows an embodiment of the invention device M-MARPE.

FIG. 2 shows an expanded view of an embodiment of the lock screw 300 and guide rails 400 of an embodiment of the invention device.

FIG. 3 shows a side view of one of the two halves 100 of an embodiment of the invention device.

FIG. 4 shows a side view of an embodiment of invention device.

FIG. 5 shows a side view of one of the two halves of an embodiment of invention device.

### DETAILED DESCRIPTION OF THE INVENTION

The invention maxillary skeletal expander device (M-MARPE) overcomes the shortcomings of the MARPE device described in U.S. Pat. No. 9,351,810, while improving the efficiency of expanding the palatal area for both young and adult patients and drastically minimizing the potential for oral health related complications. There are several key differences between the M-MARPE and the MARPE, and differences are the advantageous features of the M-MARPE device over the MARPE device.

Rather than creating holes directly on the peripheral of the body of the RPE as the MARPE does, the M-MARPE utilizes auxiliary attachments that are welded, or soldered, on to the RPE, and these auxiliary attachments are configured to maintain close physical contact with the palatal region. These attachments serve critical functions that greatly enhance the way in which the palatal region is expanded. First, the fact that the attachments maintain physical contact with the palatal region at all times allows for greater accuracy during the micro-implant implantation process because the holes in the attachments guide, or funnel, the micro-implants all the way to the desired anchorage location with precision. Second, because there is no gap between the attachments and the micro-implants, the potential for food debris to get lodged between the screw and the appliance is eliminated. This greatly reduces the likelihood of the development of foul mouth odor and poor oral hygiene in patients. Third, because the micro-implants are completely covered, or sheathed, in the attachments, they are protected from disturbances by foreign objects, thereby greatly reducing the potential for the micro-implants to become dislodged from the palatal region.

Therefore, in one aspect of the present invention, it is provided a maxillary skeletal expander device, comprising:
two halves of a device body, each halve having a middle portion and at least one anchoring leg configured to be fixed directly to a palatine bone;
at least two arms, each of the at least two arms having a proximal end fixed to one of the two halves of the device body and a distal end extending toward teeth;
a lock screw rotatably coupled to the two halves of the device body and configured to adjust a distance between the two halves of the device body;
a pair of slide rails for guiding a movement of the two halves of the device body, one slide rail having a first end slidably inserted into or fixed to a fist halve of the device body and a second end slidably inserted into a second halve of the device body, and the other slide rail having a first end slidably inserted into or fixed to the second halve of the device body and a second end slidably inserted into the first halve of the device body.

In some embodiments of the invention device, optionally in combination with any of the various embodiments disclosed herein, there can be a gap between a top surface of the anchoring leg and a portion of a top surface of the middle portion, which gap is sufficient to allow cleaning, the top surface of the anchoring leg and the top surface of the middle portion are configured to face a palate. In some embodiments, the gap can be larger than 1 mm.

In some embodiments of the invention device, optionally in combination with any of the various embodiments disclosed herein, the lock screw comprises a nut configured to be turned by a wrench.

In some embodiments invention device, optionally in combination with any of the various embodiments disclosed herein, each of the pair of slide rails includes a mechanism to prevent a disengagement of the pair of slide rails from the two halves of the device body.

In some embodiments invention device, optionally in combination with any of the various embodiments disclosed herein, the mechanism is a notch and wherein the nut includes a lock strap and wherein the notch accommodates the lock strap.

In some embodiments invention device, optionally in combination with any of the various embodiments disclosed herein, the device comprises four arms, each of the two halves of the device body having two arms attached thereto, one to its left side and the other to its right side.

In some embodiments invention device, optionally in combination with any of the various embodiments disclosed herein, the device comprising four anchoring legs, each of the two halves of the device body having two anchoring legs attached thereto, one to its left end and the other to its right end.

In some embodiments invention device, optionally in combination with any of the various embodiments disclosed herein, the device further comprises:
a pair of teeth fixing parts, the distal end of each arm attached to one halve of the device body being secured to one of the pair of teeth fixing parts, and the distal end of each arm attached to the other halve of the device body being secured to the other of the teeth fixing parts.

In some embodiments invention device, optionally in combination with any of the various embodiments disclosed herein, the device further comprises:
a pair of teeth fixing parts, the distal end of each arm attached to one halve of the device body being secured to one of the pair of teeth fixing parts, and the distal end of each arm attached to the other halve of the device body being secured to the other of the teeth fixing parts.

In some embodiments invention device, optionally in combination with any of the various embodiments disclosed herein, the anchoring leg comprises an opening to allow an implant to be inserted into the palatine bone so as to cause the maxillary skeletal expander to be fixed to the palatine bone.

In some embodiments invention device, optionally in combination with any of the various embodiments disclosed herein, the implant is a screw, a nail.

In some embodiments invention device, optionally in combination with any of the various embodiments disclosed herein, the implant has a cross-section of a circle, a square or a rectangular.

In some embodiments invention device, optionally in combination with any of the various embodiments disclosed herein, the device comprises four arms, wherein the four arms and the slide rails are configured such that:
a first arm having a distal end extending toward teeth, a proximal end slidably coupled to the first body, a portion fixed to the second body, and a slide portion extending from the portion fixed to the second body to the proximal end, the slide portion guiding a movement of the first and second bodies;
a second arm having a distal end extending toward teeth and a proximal end secured to the second body;
a third arm having a distal end extending toward teeth, a proximal end slidably coupled to the second body, a portion fixed to the first body, and a slide portion extending from the portion fixed to the first body to the proximal end, the slide portion guiding a movement of the first and second bodies; and
a fourth arm having a distal end extending toward teeth and a proximal end secured to the first body.

In some embodiments invention device, optionally in combination with any of the various embodiments disclosed herein, a width of the two legs along a direction of the movement of the two halves of the device body being less than a width of the middle portion.

In some embodiments invention device, optionally in combination with any of the various embodiments disclosed herein, the lock screw comprises a nut configured to be rotated by a wrench; and the slide rail comprises a notch that accommodates the nut to prevent a disengagement of the slide rail from the one or both halves of the device body.

In some embodiments invention device, optionally in combination with any of the various embodiments disclosed herein, the nut includes a lock strap that prevents a disengagement of the slide rail from the one or both halves of the device body.

In some embodiments invention device, optionally in combination with any of the various embodiments disclosed herein, a cross section of the slide rail has a shape of a rectangle.

In another aspect of the present invention, it is provided a method of fabricating a maxillary skeletal expander device, comprising forming the maxillary skeletal expander, the device comprising:
two halves of a device body, each halve having a middle portion and at least one anchoring leg configured to be fixed directly to a palatine bone;
at least two arms, each of the at least two arms having a proximal end fixed to one of the two halves of the device body and a distal end extending toward teeth;
a lock screw rotatably coupled to the two halves of the device body and configured to adjust a distance between the two halves of the device body;
a pair of slide rails for guiding a movement of the two halves of the device body, one slide rail having a first end slidably inserted into or fixed to a fist halve of the device body and a second end slidably inserted into a second halve of the device body, and the other slide rail having a first end slidably inserted into or fixed to the second halve of the device body and a second end slidably inserted into the first halve of the device body.

In some embodiments of the invention method, optionally in combination with any of the various embodiments disclosed herein, the maxillary skeletal expander device is according to the various embodiments disclosed above and below.

In some embodiments of the invention method, optionally in combination with any of the various embodiments disclosed herein, a metallic or non-metallic material (e.g., a biocompatible polymeric material) can be used to form any or all parts of the device.

The teaching of U.S. Pat. No. 9,351,810 is incorporated herein in its entirety.

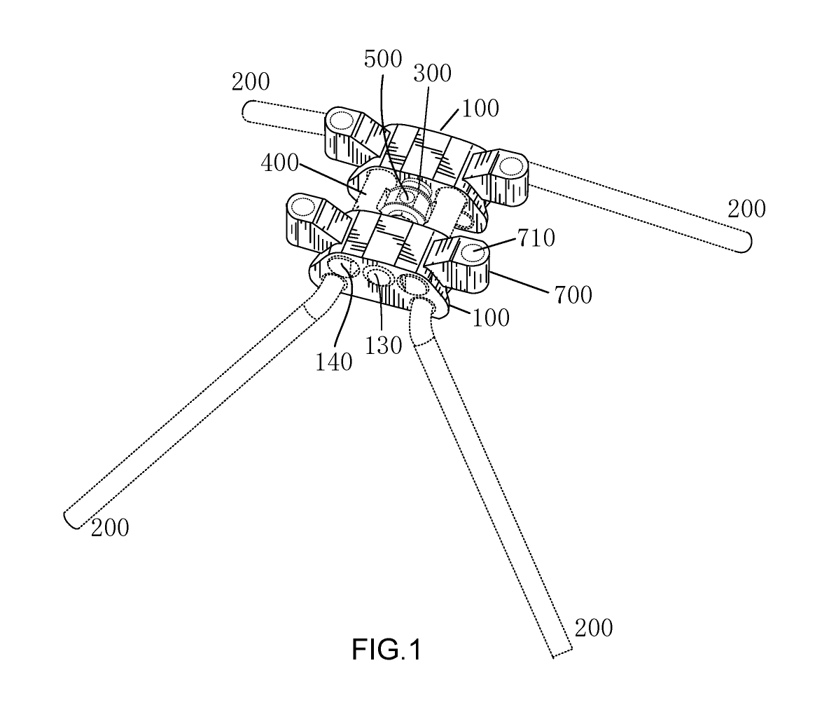

FIGS. 1-5 describe a few embodiments of the invention device. In FIG. 1, an embodiment of the invention M-MARPE device is shown, viewed from the palatal bone contact surface, to have two halves 100, four arms 200, a lock screw 300 built with a turning key hole 500, two guide rails 400, four anchoring legs 700, each with an implant insertion opening 710.

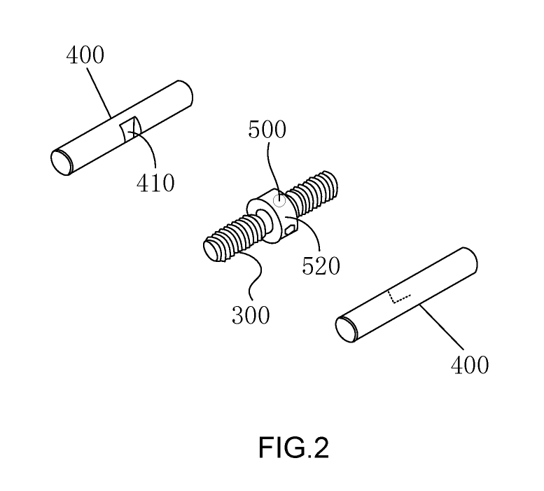

An expanded view of an embodiment of the lock screw 300 and guide rails 400 is shown in FIG. 2, where the lock screw is shown to include a nut 520 on which the turning key hole 500 is built. In some embodiments, the nut 520 can be configured to allow the lock screw 300 to be turned using a wrench. Guide rails 400 are shown to include a notch 410 to accommodate nut 520 on lock screw 300.

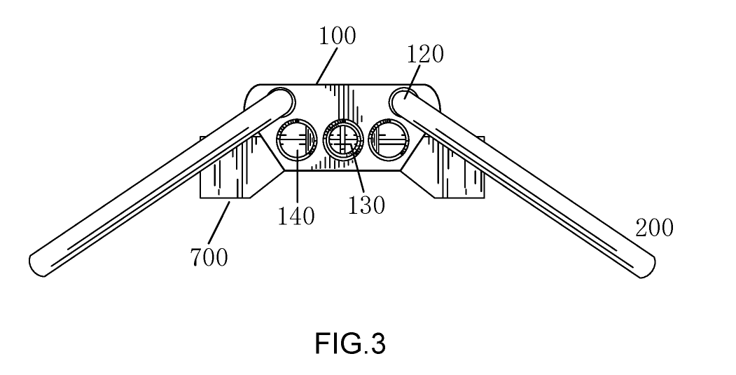

FIG. 3 shows a side view of one of the two halves 100 of an embodiment of the invention device, showing two arms 200, attachment point or insertion point 120 for arm 200, lock screw hole 130 to receive one end of the lock screw 300, a pair of holes 140 to receive guide rails 400, and two anchoring legs 700.

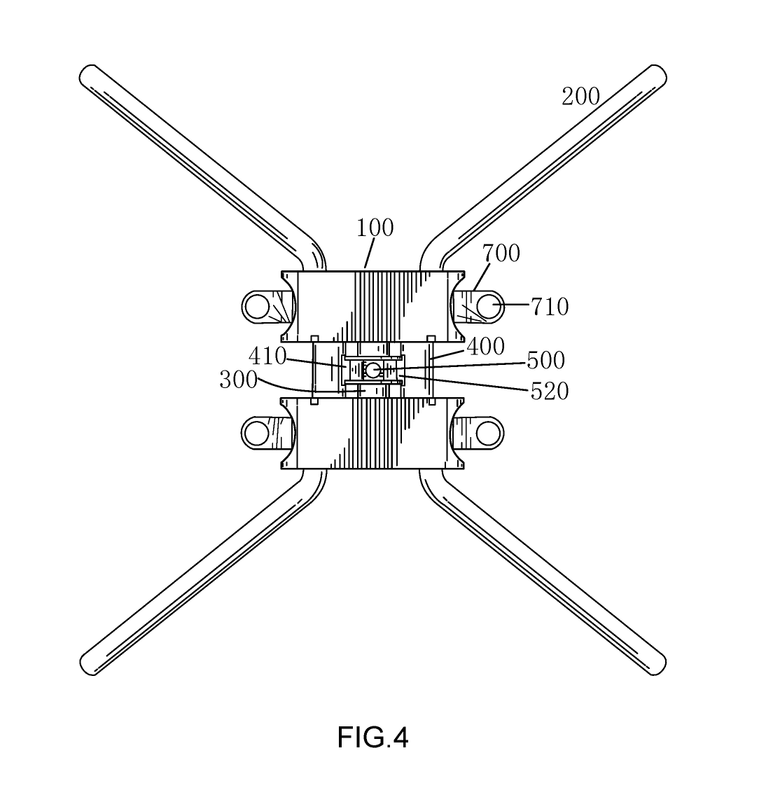

A side view of an embodiment of invention device is shown in FIG. 4, viewed from the surface away from the palatal bone, showing that the device includes two halves 100, four arms 200, a lock screw 300 with a turning hole 500 on a nut 520, two guide rails 400 with a notch to accommodate nut 520, four anchoring legs 700, each with an opening 710 for implant insertion.

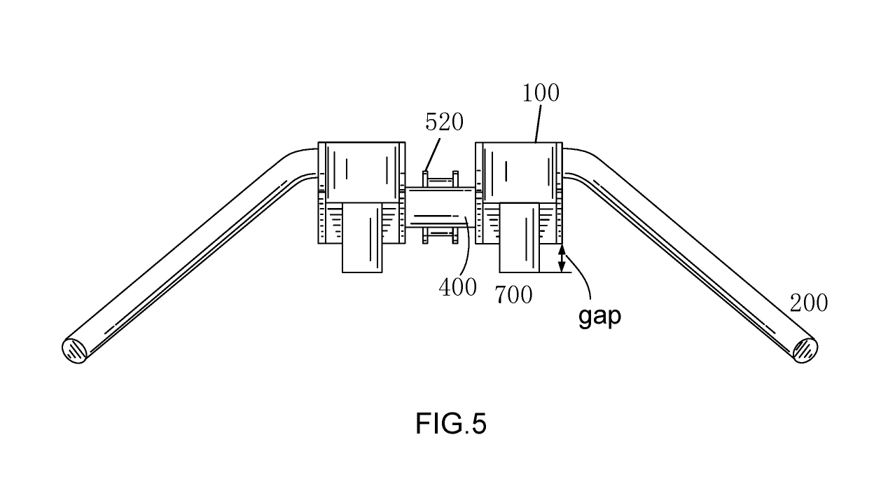

FIG. 5 shows a side view of one of the two halves of an embodiment of invention device, showing one halve of the device body 100, two arms 200, a nut 520 on lock screw 300 (not shown), a guide rail 400, and two anchoring legs 700 where the surface of the anchoring leg in contact with the palatal bone and the surface of the two halves 100 of the device body facing the palatal bone are shown to have a gap in height.

### Methods of Fabrication

The invention device can be readily fabricated according to a prescription by a person of ordinary skill in the art. Generally, the process of fabricating an invention device comprises the following steps:
1) detecting a maxillary skeletal disorder in a patient;
2) prescribing a maxillary skeletal expander device of invention to correct the maxillary skeletal disorder in the patient;
3) fabricating the maxillary skeletal expander device of invention.

The maxillary skeletal expander device is as any of the embodiments of the invention device described above.

The maxillary skeletal expander device of invention can be made from any biocompatible material having suitable mechanical strength as a maxillary skeletal expander device. Such material can be a metallic material or non-metallic material or both. Such biocompatible materials are well documented in the biomedical field, which include, for example, metallic materials such as titanium, zirconium, stainless steel, nitinol, aluminum, iron, or an alloy thereof, or in some embodiments, a polymeric material such as polylacic acid or high density polyethylene.

### Method of Use

The invention device can be used to correct a maxillary skeletal disorder in a patient. Generally, the method of using an invention device comprises the following steps:
1) detecting a maxillary skeletal disorder in a patient;
2) prescribing a maxillary skeletal expander device of invention to correct the maxillary skeletal disorder in the patient;
3) fabricating the maxillary skeletal expander device of invention;
4) applying the maxillary skeletal expander device of invention to the patient; and
5) periodically adjusting the maxillary skeletal expander device by turning the lock screw on the device until a desired result of maxillary skeletal expansion is achieved.

The maxillary skeletal expander device is as any of the embodiments of the invention device described above.

Those skilled in the art will know, or be able to ascertain, using no more than routine experimentation, many equivalents to the specific embodiments of the invention described herein. These and all other equivalents are intended to be encompassed by the following claims.

I claim:

1. A maxillary skeletal expander device, comprising:
two halves of a device body, each halve having a middle portion and at least one anchoring leg configured to be fixed directly to a palatine bone;
at least two arms, each of the at least two arms having a proximal end fixed to one of the two halves of the device body and a distal end extending toward teeth;
a lock screw rotatably coupled to the two halves of the device body and configured to adjust a distance between the two halves of the device body;
a pair of slide rails for guiding a movement of the two halves of the device body, one slide rail having a first end slidably inserted into or fixed to a fist halve of the device body and a second end slidably inserted into a second halve of the device body, and the other slide rail having a first end slidably inserted into or fixed to the second halve of the device body and a second end slidably inserted into the first halve of the device body.

2. The maxillary skeletal expander device of claim 1, wherein a gap between a top surface of the anchoring leg and a portion of a top surface of the middle portion is sufficient to allow cleaning, the top surface of the anchoring leg and the top surface of the middle portion are configured to face a palate.

3. The maxillary skeletal expander device of claim 2, wherein the gap is larger than 1 mm.

4. The maxillary skeletal expander device of claim 1, wherein the lock screw comprises a nut configured to be turned by a wrench.

5. The maxillary skeletal expander device of claim 4, wherein each of the pair of slide rails includes a mechanism to prevent a disengagement of the pair of slide rails from the two halves of the device body.

6. The maxillary skeletal expander device of claim 5, wherein the mechanism is a notch and wherein the nut includes a lock strap and wherein the notch accommodates the lock strap.

7. The maxillary skeletal expander device of claim 1, comprising four arms, each of the two halves of the device body having two arms attached thereto, one to its left side and the other to its right side.

8. The maxillary skeletal expander device of claim 1, comprising four anchoring legs, each of the two halves of the device body having two anchoring legs attached thereto, one to its left end and the other to its right end.

9. The maxillary skeletal expander device of claim 1, further comprising:
a pair of teeth fixing parts, the distal end of each arm attached to one halve of the device body being secured to one of the pair of teeth fixing parts, and the distal end of each arm attached to the other halve of the device body being secured to the other of the teeth fixing parts.

10. The maxillary skeletal expander device of claim 5, further comprising:
a pair of teeth fixing parts, the distal end of each arm attached to one halve of the device body being secured to one of the pair of teeth fixing parts, and the distal end of each arm attached to the other halve of the device body being secured to the other of the teeth fixing parts.

11. The maxillary skeletal expander device of claim 1, wherein the anchoring leg comprises an opening to allow an implant to be inserted into the palatine bone so as to cause the maxillary skeletal expander to be fixed to the palatine bone.

12. The maxillary skeletal expander device of claim 11, wherein the implant is a screw, a nail.

13. The maxillary skeletal expander device of claim 11, wherein the implant has a cross-section of a circle, a square or a rectangular.

14. The maxillary skeletal expander device of claim 1, comprising four arms, wherein the four arms and the slide rails are configured such that:
a first arm having a distal end extending toward teeth, a proximal end slidably coupled to the first body, a portion fixed to the second body, and a slide portion extending from the portion fixed to the second body to the proximal end, the slide portion guiding a movement of the first and second bodies;
a second arm having a distal end extending toward teeth and a proximal end secured to the second body;
a third arm having a distal end extending toward teeth, a proximal end slidably coupled to the second body, a portion fixed to the first body, and a slide portion extending from the portion fixed to the first body to the proximal end, the slide portion guiding a movement of the first and second bodies; and
a fourth arm having a distal end extending toward teeth and a proximal end secured to the first body.

15. The maxillary skeletal expander device of claim 1, wherein a width of the two legs along a direction of the movement of the two halves of the device body being less than a width of the middle portion.

16. The maxillary skeletal expander device of claim 1, wherein the lock screw comprises a nut configured to be rotated by a wrench; and the slide rail comprises a notch that accommodates the nut to prevent a disengagement of the slide rail from the one or both halves of the device body.

17. The maxillary skeletal expander device of claim 16, wherein the nut includes a lock strap that prevents a disengagement of the slide rail from the one or both halves of the device body.

18. The maxillary skeletal expander device of claim 16, wherein a cross section of the slide rail has a shape of a rectangle.

19. A method of fabricating a maxillary skeletal expander device, comprising:
detecting a maxillary skeletal disorder in a patient;
prescribing a maxillary skeletal expander device of invention to correct the maxillary skeletal disorder in the patient;
fabricating the maxillary skeletal expander device of invention;
applying the maxillary skeletal expander device of invention to the patient; and
periodically adjusting the maxillary skeletal expander device by turning the lock screw on the device until a desired result of maxillary skeletal expansion is achieved,
wherein the maxillary skeletal expander device is according to claim 1.

20. A method of treating a maxillary skeletal disorder, comprising:
detecting a maxillary skeletal disorder in a patient;
prescribing a maxillary skeletal expander device of invention to correct the maxillary skeletal disorder in the patient;
fabricating the maxillary skeletal expander device of invention;
applying the maxillary skeletal expander device of invention to the patient; and
periodically adjusting the maxillary skeletal expander device by turning the lock screw on the device until a desired result of maxillary skeletal expansion is achieved, wherein the maxillary skeletal expander device is according to claim 1.
